(19) United States
(12) Patent Application Publication
(10) Pub. No.: US 2010/0305018 A1
(43) Pub. Date: Dec. 2, 2010

(54) ESTERIFIED ALKYL ALKOXYLATES AS SOLID LOW-FOAM WETTERS

(75) Inventors: Christian Bittner, Bensheim (DE); Juergen Tropsch, Roemerberg (DE); Rolf-Dieter Kahl, Hassloch (DE); Michael Stoesser, Neuhofen (DE); Markus Kummeter, Heddesheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/675,472

(22) PCT Filed: Aug. 28, 2008
(86) PCT No.: PCT/EP2008/061281

§ 371 Date: Jul. 29, 2010

(30) Foreign Application Priority Data
Aug. 29, 2007 (EP) 07115192.2

(51) Int. Cl. C11D 1/825; C11D 1/68; C11D 1/722

(52) U.S. Cl. 510/220; 510/506

(57) ABSTRACT

The present invention relates to low-foam surfactant mixtures comprising esters of the general formula (I)

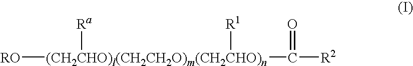

and alcohols thereof of the general formula (Ia)

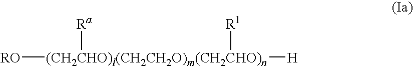

where
R is a branched or unbranched alkyl radical having from 8 to 22 carbon atoms;
R^{a}, R¹ are each independently hydrogen or a branched or unbranched alkyl radical having from 1 to 5 carbon atoms;
R² is a branched or unbranched alkyl radical having from 5 to 17 carbon atoms;
l, n are each independently from 1 to 5 and
m is from 38 to 70, and
where the ratio of the molar amounts of the esters (I) to the alcohols (Ia) is at least 17:3.

The invention further relates to the process for preparing them and to their use and to washing and cleaning composition formulations comprising them.

The present invention relates to low-foam surfactant mixtures, to processes for their preparation and to their use, and to washing or cleaning composition formulations comprising them.

Surfactants are substances which can lower interface tension. Typically, surfactants possess a characteristic structure and have at least one hydrophilic group and at least one hydrophobic functional group. When the two parts of the molecule are in equilibrium with respect to one another, the substance will accumulate and become aligned at an interface, i.e. hydrophilic groups point, for example into an aqueous phase and the hydrophobic groups in the direction of other solid, liquid or gaseous phases. A further special feature of surfactants is the formation of higher aggregates, known as micelles. In these, the surfactant molecules become ordered in such a way that the polar groups, for example, form a spherical surface. This has the effect that substances such as soil particles are solubilized in an aqueous solution with formation of micelles.

Surfactants are therefore suitable especially for cleaning surfaces and as an additive in washing compositions.

Surfactants which have a hydrophobic component and a hydrophilic component are widespread. However, their tendency to form foam makes them unsuitable or suitable only to a limited degree for many applications. Therefore, especially nonionic surfactants which have a second hydrophobic block have been proposed, such that the foam volume is limited.

DE-A 12 43 312 describes, for example, the use of alkyl alkoxylates which are esterified with an aliphatic short-chain or aromatic carboxylic acid as low-foam nonionic surfactants.

Similar compounds are disclosed in DE-A 25 44 707. Here, too the acid component is formed by a short-chain aliphatic acid, specifically acetic acid.

EP-A 035 702 discloses foam suppressants which comprise nonionic surfactants. These surfactants should comprise from 3 to 10 ethylene oxide units.

WO-A 94/03251 discloses end group-capped antifoams in which the alcohol component used is a fatty alcohol polyglycol ether, which likewise preferably comprises 10 ethylene oxide or propylene oxide units.

Furthermore, WO-A 2006/097435 describes low-foam surfactant mixtures, which have good properties with regard to foam suppression. These possess up to 35 ethylene glycol units and are present in the form of an ester. However, a disadvantage of these surfactant mixtures is that they have a melting point in the range of about 30-33° C., and so they are not very suitable for solid washing and cleaning composition formulations.

There is therefore a need for alternative low-foam surfactant mixtures.

It is thus an object of the present invention to provide such surfactant mixtures.

The object is achieved by a low-foam surfactant mixture

comprising esters of the general formula (I)

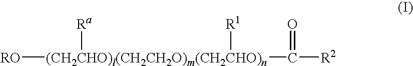

and alcohols thereof of the general formula (Ia)

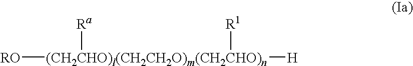

where
R is a branched or unbranched alkyl radical having from 8 to 22 carbon atoms;
R^{a}, R¹ are each independently hydrogen or a branched or unbranched alkyl radical having from 1 to 5 carbon atoms;
R² is a branched or unbranched alkyl radical having from 5 to 17 carbon atoms;
l, n are each independently from 1 to 5 and
m is from 38 to 70, and
   where the ratio of the molar amounts of the esters (I) to the alcohols (Ia) is at least 17:3.

This is because it has been found that the inventive surfactant mixtures have a higher melting point as compared with the mixtures from WO-A 2006/097435 owing to their higher number of ethylene glycol units, although, surprisingly, comparable foam suppression effects can be achieved only when the ratio of the molar amount of the esters(I) to the alcohols (Ia) is at least 17:3, which corresponds to a degree of esterification of at least 85%.

In this context, the inventive surfactant mixtures have very high HLB values, while, however, comparatively outstanding foam suppression is preferably present within a temperature range of 0-120° C.

The HLB value is calculated as the quotient of the amount of ethylene oxide to the total amount×20. In general the HLB value is defined by the formula

$$HLB = 20 ( 1 - \frac{{M}_{L}}{{M}_{G}} ) ,$$

where M_{L} is the molecular weight of lipophilic fractions and M_{G} is the total weight. Further details on this subject can be found in H.-D. Dörter, Grenzflächen und kolloid-disperse Systeme [Interfaces and colloidally dispersed systems], Springer Verlag 2002, chapter 9.3 “Physikalische Eigenschaften und Wirkungen der Tenside” [“Physical properties and effects of the surfactants”].

The inventive low-foam surfactant mixtures typically have an HLB value of more than 17.7 and preferably less than 18.5.

Surfactant mixtures according to the present invention may comprise esters of the general formula (II)

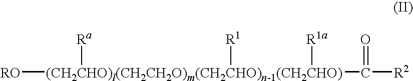

and alcohols thereof of the general formula (IIa)

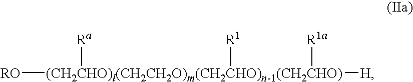

where R^{1a} is a branched or unbranched alkyl radical having from 1 to 5 carbon atoms and R, R^{a}, R¹, R², l, m and n are each as defined above.

In the context of the present invention, the expression “alkyl radical” means a saturated branched or unbranched aliphatic hydrocarbon radical with the number of carbon atoms specified in each case.

The ratio of the molar amounts of the esters (I) to the alcohols (Ia) or (II):(IIa), is at least 17:3, which corresponds to a degree of esterification of at least 85%.

The ratio is preferably 7:1 (corresponding to a degree of esterification of 87.5%) more preferably at least 9:1 (corresponding to 90%), more preferably at least 37:3 (at least 92.5%), more preferably at least 19:1 (at least 95%) and more preferably at least 39:1 (at least 97.5%).

The ratio can be determined by means of ¹H NMR and/or via the amount of water removed in the esterification. The person skilled in the art is aware of further methods.

The low-foam surfactant mixture of the present invention does not comprise exclusively esters of the general formula (I) or (II), which corresponds to a degree of esterification of 100% (full esterification).

Typically, the ratio of the molar amount of the esters (I) to the alcohols (Ia) or (II):(IIa) is at most 999:1 (a degree of esterification of at most 99.9%), more preferably at most 199:1 (at most 99.5%) and even more preferably at most 99:1 (at most 99%).

The R radical is preferably a branched or unbranched alkyl radical having from 12 to 22 carbon atoms. When the alkyl radical is branched, the degree of branching is preferably 1-3. In the context of the present invention, the term “degree of branching” is the number of methyl groups minus 1.

Further preferably R^{a}, R¹ are each independently hydrogen, methyl or ethyl. When R^{a}, R¹ occur more frequently, each can be selected independently from a further R^{a} or R¹. Thus, R^{a} and R¹ may occur in blockwise or random distribution.

R^{a}, R¹ are preferably in blockwise distribution, especially in each case at the end of the ethylene glycol chain.

R^{1a} is preferably methyl or ethyl.

R² is preferably a branched or unbranched alkyl radical having from 5 to 13 carbon atoms.

Preferably, n=1, l=5 and m is preferably from 39 to 54, more preferably from 39 to 49.

In a further embodiment R^{a}, R¹═H, such that the surfactant mixture comprises exclusively unsubstituted ethylene glycol units.

Further preferably, the sum of l+n+m is from 40 to 80, more preferably from 41 to 80, even more preferably from 45 to 75, even more preferably from 46 to 75 and especially from 50 to 70.

Further preferably, the mean molecular weight (weight-average) is within a range from 1800 g/mol to 4000 g/mol. More preferably, the mean molecular weight is within a range from 2000 g/mol to 3500 g/mol.

Preferably, more than 50% of the compounds of the surfactant mixture according to the present invention are compounds of the formula (I) and (Ia) or of the formula (II) and (IIa). More preferably, the proportion of this compound in the inventive surfactant mixture is more than 60%, more preferably more than 70%, more preferably more than 75%, more preferably more than 80%, more preferably more than 85% and especially more than 90%.

The inventive surfactant mixture preferably has a beginning of the melting range which is above 35° C., more preferably above 40° C. and especially above 45° C.

The present invention further provides the preparation of surfactant mixtures, comprising the steps of:
a) reacting an alcohol of the formula ROH with an epoxide of the formula

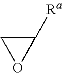

and then with ethylene oxide;
b) reacting the product from step a) with an epoxide of the formula

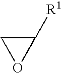

and optionally with an epoxide of the formula

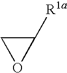

c) reacting the product formed from step b) with a carboxylic acid R²—COOH or a methyl ester R²—COOCH₃, where R¹, R^{1a} and R² are each as defined in claim 1 or 2.

When R^{a}═H is in step a), the reaction is effected only with ethylene oxide.

Preference is given to effecting steps a) and b) by anhydrous base-catalyzed reaction. In this case, the base used is preferably sodium hydroxide or potassium hydroxide. The temperature range is preferably from 50 to 200° C.

The reaction in step c) is effected preferably under acid or base catalysis; the acid used is preferably sulfuric acid or paratoluenesulfonic acid. The temperature range in step c) may be from 80 to 200° C. The reaction in step c) preferably takes place with continuous removal of the water of reaction or methanol. This is done, for example, at standard pressure and/or stripping with nitrogen or reduced pressure or by use of an azeotroping agent, for example toluene or xylene in the case of water.

The inventive surfactant mixtures are suitable particularly in washing and cleaning composition formulations. The present invention therefore further provides a washing or cleaning composition formulation comprising an inventive surfactant mixture.

Accordingly, the present invention also relates to the use of an inventive surfactant mixture in washing and cleaning formulations, especially in formulations which are present in solid form at room temperature.

More preferably, the surfactant mixtures find use in so-called “2 in 1” or “3 in 1” tabs. Further details of these formulations can be found in Hermann G. Hauthal, G. Wagner (eds), Reinigungs- and Pflegemittel im Haushalt [Cleaning and care compositions in the household], Verlag für chemische Industrie, H. Ziolkowsky GmbH, Augsburg 2003, chapter 4.2, pages 161-184.

Washing compositions in the context of this invention serve generally for washing of more or less flexible materials, preferably those which comprise natural, synthetic or semi-synthetic fiber materials or consist thereof, and which accordingly generally have textile character at least in part. The fibrous materials or materials consisting of fibers may, in principle be present in any form which occurs in use or in manufacture and processing. For example, fibers may be present in unordered form in the form of staple or aggregate, in ordered form in the form of fibers, yarns, threads, or in the form of three-dimensional structures such as nonwovens, lodens or felt, wovens, knits, in all conceivable binding types.

They may be raw fibers or fibers at any processing stages and may be natural protein or cellulose fibers such as wool, silk, cotton, sisal, hemp, coconut fibers or synthetic fibers, for example, polyester, polyamide or polyacrylonitrile fibers.

The inventive washing compositions may also be used particularly advantageously in the processing of fiber materials, for example, for the degreasing of raw wool or for the desizing of fiber materials of all kinds.

The inventive washing compositions may also serve for cleaning of fibrous materials, for example backed carpets with cut or uncut pile.

The inventive cleaning composition is particularly suitable for cleaning materials with a continuous, especially hard, surface, i.e. surfaces which have only a few small pores, if any, and consequently have only a low absorption, if any. Materials with continuous surfaces are predominantly hard, but may also be soft in the sense that they have a certain reversible or irreversible deformability.

Examples of materials with hard surfaces for whose cleaning the inventive cleaning compositions are preferably used are metal, glass, enamel, ceramic. Typical objects made from these materials are, for example, metal sinks, cutlery, glass and porcelain dishware, baths, washbasins, tiles and hardened synthetic resins, for example decorative melamine resin surfaces on kitchen furniture, or finished metal surfaces for example refrigerators and automobile bodies. The inventive cleaning compositions are also very valuable assistants in the production of printed circuits where it is important to remove grease traces and other contaminations from copper-, or silver-laminated substrates before the etching and/or before the assembly and/or to thoroughly remove soldering fluxes or other flux residues after the assembly.

In the manufacture of microchips too, the inventive cleaning compositions can perform valuable services. Materials with continuous, especially hard, surfaces, in the context of this invention may also have fissured surfaces, as found, for example, in the cementitious materials.

Examples of softer materials which can be cleaned with the inventive cleaning compositions are, for example, sealed or varnished wood, for example, parquet, or wall paneling, window frames, doors, plastic coverings such as floor coverings made of PVC or hard rubber, or hard or soft foams with substantially continuous surfaces.

More particularly, the inventive detergents can be used as manual dishwashing detergents, machine dishwashing detergents, metal degreasers, glass cleaners, floor cleaners, all-purpose cleaners, high-pressure cleaners, neutral cleaners, alkaline cleaners, acidic cleaners, spray degreasers, dairy cleaners, industrial kitchen cleaners, apparatus cleaners in industry, especially in the chemical industry, as cleaners in carwashes, but also as domestic all-purpose cleaners.

It will be appreciated that the compositions of the washing and cleaning compositions will be adjusted to the different purposes, as is familiar to the person skilled in the art from the prior art. For this purpose, all assistants and additives which are known from the abovementioned prior art and are appropriate to the purpose can be added to the inventive washing and cleaning compositions.

In many cases, it is appropriate to combine the surfactant mixtures of the formula (I) used in accordance with the invention with other nonionic surfactants, for example alcohol alkoxylates, alkylamine alkoxylates, alkylamide alkoxylates, alkyl polyglucosides, or with ionic preferably anionic, surfactants, for example relatively long-chain or long-chain alcohol sulfates/ether sulfates, alkylbenzenesulfonates, α-olefinsulfonates, sulfosuccinates, or with amphoteric surfactants, for example alkylamine oxides, or betaines.

Examples of surfactants of different nature suitable for combination are specified below:

Suitable nonionic surfactants are, for example, alkoxylated C₈- to C₂₂-alcohols such as fatty alcohol alkoxylates or oxo alcohol alkoxylates. The alkoxylation can be carried out with ethylene oxide, propylene oxide and/or butylene oxide. Usable surfactants here are all alkoxylated alcohols, which preferably comprise at least two molecules of an aforementioned alkylene oxide added on. Here, too, block polymers of ethylene oxide, propylene oxide and/or butylene oxide are useful, as are addition products which comprise the alkylene oxides mentioned in random distribution. Per mol of alcohol, from 2 to 50, and preferably from 3 to 20 mol of at least one alkylene oxide are used. The alkylene oxide used is preferably ethylene oxide. The alcohols have preferably from 10 to 18 carbon atoms. According to the type of alkoxylation catalyst, alkoxylates with wide or narrow alkylene oxide homolog distribution can be obtained.

A further class of suitable nonionic surfactants is that of alkylphenol alkoxylates such as alkylphenol ethoxylates with C₆ to C₁₄-alkyl chains and from 5 to 30 mol of alkylene oxide units.

Another class of nonionic surfactants is that of alkyl polyglucosides having from 6 to 22, and preferably from 8 to 18 carbon atoms in the alkyl chain. These compounds usually comprise from 1 to 20, and preferably from 1.1 to 5 glucoside units.

Another class of nonionic surfactants is that of N-alkylglucamides of the general structures

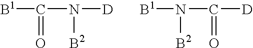

where B¹ is a C₆- to C₂₂-alkyl, B² is hydrogen or C₁- to C₄-alkyl and D is a polyhydroxyalkyl radical having from 5 to 12 carbon atoms and at least 3 hydroxy groups. B¹ is preferably C₁₀- to C₁₈-alkyl, B² is CH₃ and D is a C₅ or C₆ radical. For example, such compounds are obtained by the acylation of reductively aminated sugars with acid chlorides of C₁₀- to C₁₈-carboxylic acids.

Further useful nonionic surfactants are the end group-capped fatty acid amide alkoxylates which are known from WO-A 95/11225 and are of the general formula

R¹—CO—NH—(CH₂)_{y}—O-(A¹O)ₓ—R²

in which
R¹ is a C₅- to C₂₁-alkyl or alkenyl radical,
R² is a C₁- to C₄-alkyl group,
A¹ is C₂- to C₄alkylene,
y is 2 or 3 and
x is from 1 to 6.

Examples of such compounds are the reaction products of n-butyltriglycolamine of the formula H₂N—(CH₂—CH₂—O)₃—C₄H₉ with methyl dodecanoate, or the reaction products of ethyltetraglycolamine of the formula H₂N—(CH₂—CH₂—O)₄—C₂H₅ with a commercial mixture of saturated C₈ to C₁₈ fatty acid methyl esters.

Additionally suitable as nonionic surfactants are also block copolymers formed from ethylene oxide, propylene oxide and/or butylene oxide (Pluronic® and Tetronic® brands from BASF), polyhydroxy or polyalkoxy fatty acid derivatives such as polyhydroxy fatty acid amides, N-alkoxy or N-aryloxy polyhydroxy fatty acid amides, fatty acid amide ethoxylates, especially end group-capped and fatty acid alkanolamide alkoxylates.

The additional nonionic surfactants are present in the inventive washing and cleaning compositions preferably in an amount of 0.01 to 30% by weight, especially from 0.1 to 25% by weight, and in particular from 0.5 to 20% by weight.

It is possible to use individual nonionic surfactants or a combination of different nonionic surfactants. It is possible to use nonionic surfactants from only one class, especially only alkoxylated C₈- to C₂₂-alcohols, but it is also possible to use surfactant mixtures from different classes.

Suitable anionic surfactants are, for example, fatty alcohol sulfates of fatty alcohols having from 8 to 22, and preferably from 10 to 18 carbon atoms, for example C₉-C₁₁-alcohol sulfates, C₁₂-C₁₄-alcohol sulfates, C₁₂-C₁₈-alcohol sulfates, lauryl sulfate, cetyl sulfate, myristyl sulfate, palmitoyl sulfate, stearyl sulfate and tallow fat alcohol sulfate.

Further suitable anionic surfactants are sulfated ethoxylated C₈-C₂₂-alcohols (alkyl ether sulfates) and soluble salts thereof. Compounds of this type are prepared, for example, by first alkoxylating a C₈- to C₂₂-, and preferably a C₁₀-C₁₈-alcohol, for example a fatty alcohol, and then sulfating the alkoxylation product. For the alkoxylation, preference is given to using ethylene oxide, in which case from 1 to 50, and preferably from 1 to 20 mol of ethylene oxide are used per mole of alcohol. However, the alkoxylation of the alcohols can also be carried out with propylene oxide alone and if appropriate butylene oxide. Also suitable are those alkoxylated C₈-C₂₂-alcohols, which comprise ethylene oxide and propylene oxide or ethylene oxide and butylene oxide or ethylene oxide and propylene oxide and butylene oxide. The alkoxylated C₈-C₂₂-alcohols may comprise the ethylene oxide, propylene oxide and butylene oxide units in the form of blocks or in random distribution. According to the type of alkoxylation catalyst, it is possible to obtain alkyl ether sulfates with a broad or narrow alkylene oxide homolog distribution.

Further suitable anionic surfactants are alkanesulfonates such as C₈-C₂₄-, and preferably C₁₀-C₁₈-alkanesulfonates and also soaps, for example the sodium and potassium salts of C₈-C₂₄-carboxylic acids.

Further suitable anionic surfactants are linear C₈-C₂₀-alkylbenzenesulfonates (“LAS”), preferably linear C₉-C₁₃-alkylbenzenesulfonates and alkyltoluenesulfonates.

Also suitable as anionic surfactants are C₈-C₂₄-olefinsulfonates and -disulfonates, which may also be mixtures of alkene- and hydroxyalkanesulfonates or -disulfonates, or alkyl ester sulfonates, sulfonated polycarboxylic acids, alkylglyceryl sulfonates, fatty acid glyceryl ester sulfonates, alkylphenol polyglycol ether sulfates, paraffinsulfonates having from approx. 20 to approx. 50 carbon atoms (based on paraffin or paraffin mixtures obtained from natural sources), alkyl phosphates, acyl isethionates, acyl taurates, acyl methyltaurates, alkylsuccinic acids, alkenylsuccinic acids, or monoesters or monoamides thereof, alkylsulfosuccinic acids or amides thereof, mono- and diesters of sulfosuccinic acids, acyl sarcosinates, sulfated alkyl polyglucosides, alkylpolyglycol carboxylates and hydroxyalkyl sarcosinates.

The anionic surfactants are added to the washing and cleaning compositions preferably in the form of salts. Suitable cations in these salts are alkali metal ions such as sodium, potassium and lithium and ammonium salts, for example hydroxyethylammonium, di(hydroxyethyl)ammonium and tri(hydroxyethyl)ammonium salts. The anionic surfactants are present in the inventive washing compositions preferably in an amount of up to 30% by weight, for example from 0.1 to 30% by weight, in particular from 1 to 25% by weight, and especially 3 to 20% by weight. When C₉-C₂₀ linear alkylbenzenesulfonates (LAS) are also used, they are typically used in an amount of up to 15% by weight, especially up to 10% by weight.

In the inventive cleaning compositions, the anionic surfactants are present in an amount of up to 30% by weight, in particular up to 25% by weight, especially up to 15% by weight. When C₉-C₂₀ linear alkylbenzenesulfonates (LAS) are also used, they are used typically in an amount of up to 10% by weight, especially up to 8% by weight.

It is possible to use individual anionic surfactants or a combination of different anionic surfactants. It is possible to use anionic surfactants from only one class, for example only fatty alcohol sulfates or only alkylbenzenesulfonates, but it is also possible to use surfactant mixtures from different classes, for example a mixture of fatty alcohol sulfates and alkylbenzenesulfonates.

It is also possible to combine the surfactant mixtures of the formula (I) to be used in accordance with the invention with cationic surfactants, typically in an amount of up to 25% by weight, preferably from 0.1 to 15% by weight, for example C₈-C₁₆-dialkyldimethylammonium halides, dialkoxydimethylammonium halides or imidazolinium salts with a long-chain alkyl radical; and/or with amphoteric surfactants, typically in an amount of up to 15% by weight, preferably from 0.1 to 10% by weight, for example derivatives of secondary or tertiary amines for example C₆-C₁₈-alkyl betaines or C₆-C₁₆-alkyl sulfobetaines or amine oxides such as alkyldimethylamine oxides.

In general, the surfactant mixtures of the formula (I) to be used in accordance with the invention are combined with builders (sequestrants) for example polyphosphates, polycarboxylates, phosphonates, complexing agents, for example methylglycinediacetic acid and salts thereof, nitrilotriacetic acid and salts thereof, ethylenediaminetetraacetic acid and salts thereof, and if appropriate with co-builders.

Individual very suitable builder substances for combination with the surfactant mixtures of the formula (I) to be used in accordance with the invention are enumerated below:

Suitable inorganic builders are in particular crystalline or amorphous aluminosilicates with ion-exchanging properties, especially zeolites. Various types of zeolites are suitable, especially zeolites A, X, B, P, MAP and HS in their sodium form or in forms in which sodium has been exchanged partly for other cations such as lithium, potassium, calcium, magnesium or ammonium. Suitable zeolites are, for example, described in U.S. Pat. No. 4,604,224.

Crystalline silicates suitable as builders are, for example, disilicates or sheet silicates, for example δ-Na₂Si₂O₆ or β-Na₂Si₂O₅ (SKS 6 and SKS 7 respectively). The silicates may be used in the form of the alkali metal, alkaline earth metal or ammonium salts, preferably in the form of sodium silicates, lithium silicates and magnesium silicates. Amorphous silicates for example sodium metasilicate, which has a polymeric structure, or amorphous disilicate (Britesil® H 20, manufacturer: Akzo) can likewise be used.

Suitable inorganic builder substances based on carbonate are carbonates and hydrogencarbonates. These may be used in the form of their alkali metal, alkaline earth metal or ammonium salts. Preference is given to using sodium, lithium and magnesium carbonates or sodium, lithium and magnesium hydrogencarbonates, especially sodium carbonate and/or sodium hydrogencarbonate. Customary phosphates used as inorganic builders are alkali metal orthophosphates and/or polyphosphates for example pentasodium triphosphate. The builder components mentioned may be used individually or in mixtures with one another.

In addition, it is in many cases appropriate to add co-builders to the inventive washing and cleaning compositions. Examples of suitable substances are listed below:

In a preferred embodiment, the inventive washing and cleaning compositions comprise, in addition to the inorganic builders, from 0.05 to 20% by weight, and especially from 1 to 10% by weight of organic co-builders in the form of low molecular weight oligomeric or polymeric carboxylic acids, especially polycarboxylic acids, or phosphonic acids or salts thereof, especially sodium or potassium salts.

Low molecular weight carboxylic acids or phosphonic acids suitable as organic co-builders are, for example:

Phosphonic acids for example 1-hydroxyethane-1,1-diphosphonic acid, aminotris(methylenephosphonic acid), ethylenediaminetetra(methylenephosphonic acid), hexamethylenediaminetetra(methylenephosphonic acid) and diethylenetriaminepenta(methylenephosphonic acid); C₄-C₂₀-di-, -tri- and -tetracarboxylic acids, for example succinic acid, propanetricarboxylic acid, butanetetracarboxylic acid, cyclopentanetetracarboxylic acid and alkyl- and alkenylsuccinic acids with C₂-C₁₈-alkyl or -alkenyl radicals; C₄-C₂₀-hydroxycarboxylic acids for example malic acid, tartaric acid, gluconic acid, glutaric acid, citric acid, lactobionic acid and sucrosemono-, -di- and -tricarboxylic acid; aminopolycarboxylic acids for example nitrilotriacetic acid, β-alaninediacetic acid, ethylenediaminetetraacetic acid, serinediacetic acid, isoserinediacetic acid, alkylethylenediamine triacetates, N,N-bis(carboxymethyl)glutamic acid, ethylene-diaminedisuccinic acid and N-(2-hydroxyethyl)iminodiacetic acid, methyl- and ethylglycinediacetic acid.

Oligomeric or polymeric carboxylic acids suitable as organic co-builders are, for example:

Oligomaleic acids, as described, for example in EP-A 451508 and EP-A 396303; co- and terpolymers of unsaturated C₄-C₈-dicarboxylic acids, where the polymerized comonomers may include monoethylenically unsaturated monomers from the group (i) specified below in amounts of up to 95% by weight, from group (ii) in amounts of up to 60% by weight and from group (iii) in amounts of up to 20% by weight.

Suitable unsaturated C₄- to C₈-dicarboxylic acids in this context are for example, maleic acid, fumaric acid, itaconic acid and citraconic acid. Preference is given to maleic acid.

The group (i) comprises monoethylenically unsaturated C₃-C₈-monocarboxylic acids for example acrylic acid, methacrylic acid, crotonic acid and vinylacetic acid. From group (i), preference is given to using acrylic acid and methacrylic acid.

The group (ii) comprises monoethylenically unsaturated C₂-C₂₂-olefins, vinyl alkyl ethers with C₁-C₈-alkyl groups, styrene, vinyl esters of C₁-C₈-carboxylic acids, (meth)acrylamide and vinylpyrrolidone. From group (ii), preference is given to using C₂-C₆-olefins, vinyl alkyl ethers with C₁-C₄-alkyl groups, vinyl acetate and vinyl propionate.

If the polymers of group (ii) comprise vinyl esters in polymerized form, they may also be present partly or fully hydrolyzed to vinyl alcohol structural units. Suitable co- and terpolymers are known, for example, from U.S. Pat. No. 3,887,806 and DE-A 4313909.

The group (iii) comprises (meth)acrylic esters of C₁-C₈-alcohols, (meth)acrylonitrile, (meth)acrylamides of C₁-C₈-amines, N-vinylformamide and N-vinylimidazole.

Suitable organic co-builders are also homopolymers of the monoethylenically unsaturated C₃-C₈-monocarboxylic acids for example acrylic acid, methacrylic acid, crotonic acid and vinylacetic acid, especially of acrylic acid and methacrylic acid, copolymers of dicarboxylic acids, for example copolymers of maleic acid and acrylic acid in a weight ratio of 10:90 to 95:5, more preferably those in a weight ratio of from 30:70 to 90:10 with molar masses of from 1000 to 150 000;

Terpolymers of maleic acid, acrylic acid and a vinyl ester of a C₁-C₃-carboxylic acid in a weight ratio of from 10 (maleic acid):90 (acrylic acid+vinyl ester) to 95 (maleic acid):10 (acrylic acid+vinyl ester), where the weight ratio of acrylic acid to the vinyl ester may vary within the range from 30:70 to 70:30;

copolymers of maleic acid with C₂-C₈-olefins in a molar ratio of from 40:60 to 80:20, particular preference being given to copolymers of maleic acid with ethylene, propylene or isobutene in a molar ratio of 50:50.

Graft polymers of unsaturated carboxylic acids onto low molecular weight carbohydrates or hydrogenated carbohydrates, cf. U.S. Pat. No. 5,227,446, DE-A 4415623 and DE-A 4313909, are likewise suitable as organic co-builders.

Suitable unsaturated carboxylic acids in this context are, for example, maleic acid, fumaric acid, itaconic acid, citraconic acid, acrylic acid, methacrylic acid, crotonic acid and vinylacetic acid and also mixtures of acrylic acid and maleic acid, which are grafted on in amounts of from 40 to 95% by weight, based on the component to be grafted.

For modification, it is additionally possible for up to 30% by weight, based on the component to be grafted, of further monoethylenically unsaturated monomers to be present in polymerized form. Suitable modifying monomers are the abovementioned monomers of groups (ii) and (iii).

Suitable graft bases are degraded polysaccharides, for example acidically or enzymatically degraded starches, inulins or cellulose, protein hydrolyzates and reduced (hydrogenated or hydrogenatingly aminated) degraded polysaccharides, for example mannitol, sorbitol, aminosorbitol and N-alkylglucamine, as are polyalkylene glycols with molar masses of up to M_{w}=5000 for example polyethylene glycols, ethylene oxide/propylene oxide or ethylene oxide/butylene oxide or ethylene oxide/propylene oxide/butylene oxide block copolymers and alkoxylated mono- or polyhydric C₁- to C₂₂-alcohols (cf. U.S. Pat. No. 5,756,456).

Polyglyoxylic acids suitable as organic cobuilders are, for example, described in EP-B-001004, U.S. Pat. No. 5,399,286, DE-A-4106355 and EP-A-656914. The end groups of the polyglyoxylic acids may have different structures.

Polyamidocarboxylic acids and modified polyamidocarboxylic acids suitable as organic cobuilders are, for example, known from EP-A-454126, EP-B-511037, WO-A-94/01486 and EP-A-581452.

The organic cobuilders used are especially also polyaspartic acids or cocondensates of aspartic acid with further amino acids, C₄-C₂₅-mono- or -dicarboxylic acids and/or C₄-C₂₅-mono- or -diamines. Particular preference is given to using polyaspartic acids which have been prepared in phosphorus acids and have been modified with C₆-C₂₂-mono- or -dicarboxylic acids or with C₆-C₂₂-mono- or -diamines.

Suitable organic cobuilders are also iminodisuccinic acid, oxydisuccinic acid, aminopolycarboxylates, alkyl polyaminocarboxylates, aminopolyalkylenephosphonates, polyglutamates, hydrophobically modified citric acid for example agaric acid, poly-α-hydroxyacrylic acid, N-acylethylenediamine triacetates such as lauroylethylenediamine triacetate and alkylamides of ethylenediaminetetraacetic acid such EDTA tallow amide.

In addition, it is also possible to use oxidized starches as organic cobuilders.

In a further preferred embodiment, the inventive washing and cleaning compositions additionally comprise, especially in addition to the inorganic builders, the anionic surfactants and/or the nonionic surfactants, from 0.5 to 20% by weight, especially from 1 to 10% by weight, of glycine-N,N-diacetic acid derivatives, as described in WO 97/19159.

Frequently, it is also appropriate to add to the inventive washing and cleaning compositions, bleach systems consisting of bleaches, for example perborate, percarbonate, and if appropriate, bleach activators, for example tetraacetyl-ethylenediamine, +bleach stabilizers.

In these cases, the inventive washing and cleaning compositions additionally comprise from 0.5 to 30% by weight, especially from 5 to 27% by weight, and in particular from 10 to 23% by weight of bleaches in the form of percarboxylic acids, for example diperoxododecanedicarboxylic acid, phthalimidopercaproic acid or monoperoxophthalic acid or -terephthalic acid, adducts of hydrogen peroxide onto inorganic salts, for example sodium perborate monohydrate, sodium perborate tetrahydrate, sodium carbonate perhydrate or sodium phosphate perhydrate, adducts of hydrogen peroxide onto organic compounds, for example urea perhydrate, or of inorganic peroxo salts, for example alkali metal persulfates or peroxodisulfates, if appropriate in combination with from 0 to 15% by weight, preferably from 0.1 to 15% by weight, and especially from 0.5 to 8% by weight of bleach activators.

Suitable bleach activators are:
polyacylated sugars, e.g. pentaacetylglucose;
acyloxybenzenesulfonic acids and their alkali metal and alkaline earth metal salts, e.g. sodium p-nonanoyloxybenzenesulfonate or sodium p-benzoyloxybenzenesulfonate;
N,N-diacylated and N,N,N′,N′-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethylhydantoin;
N-alkyl-N-sulfonylcarbonamides, e.g. N-methyl-N-mesylacetamide or N-methyl-N-mesylbenzamide;
N-acylated cyclic hydrazides, acylated triazoles or urazoles, e.g. monoacetylmaleic hydrazide;
O,N,N-trisubstituted hydroxylamines, e.g. O-benzoyl-N,N-succinylhydroxylamine, O-acetyl-N,N-succinylhydroxylamine or O, N,N-triacetylhydroxylamine;
N,N′-diacylsulfurylamides, z.B. N,N′-dimethyl-N,N′-diacetylsulfurylamide or N,N′-diethyl-N,N′-dipropionylsulfurylamide;
acylated lactams for example acetylcaprolactam, octanoylcaprolactam, benzoylcaprolactam or carbonylbiscaprolactam;
anthranil derivatives for example 2-methylanthranil or 2-phenylanthranil;
triacyl cyanurates, e.g. triacetyl cyanurate or tribenzoyl cyanurate;
oxime esters and bisoxime esters for example O-acetylacetone oxime or bisisopropyl iminocarbonate;
carboxylic anhydrides, e.g. acetic anhydride, benzoic anhydride, m-chlorobenzoic anhydride or phthalic anhydride;
enol esters for example isopropenyl acetate;
1,3-diacyl-4,5-diacyloxyimidazolines, e.g. 1,3-diacetyl-4,5-diacetoxyimidazoline;
tetraacetylglycoluril and tetrapropionylglycoluril;
diacylated 2,5-diketopiperazines, e.g. 1,4-diacetyl-2,5-diketopiperazine;
ammonium-substituted nitriles, for example N-methylmorpholinioacetonitrile methylsulfate;
acylation products of propylenediurea and 2,2-dimethylpropylenediurea, e.g. tetraacetylpropylenediurea;
α-acyloxypolyacylmalonamides, e.g. α-acetoxy-N,N′-diacetylmalonamide;
diacyldioxohexahydro-1,3,5-triazines, z.B. 1,5-diacetyl-2,4-dioxohexahydro-1,3,5-triazine;
benz-(4H)-1,3-oxazin-4-ones with alkyl radicals, e.g. methyl, or aromatic radicals, e.g. phenyl, in the 2-position.

The bleach system composed of bleaches and bleach activators described may, if appropriate, also comprise bleach catalysts. Suitable bleach catalysts are, for example, quaternized imines and sulfonimines, which are described, for example, in U.S. Pat. No. 5,360,569 and EP-A 453 003. Particularly effective bleach catalysts are manganese complexes, which are described, for example, in WO-A 94/21777. In the case of their use in washing and cleaning compositions, such compounds are incorporated at most in amounts up to 1.5% by weight, especially up to 0.5% by weight, and in the case of very active manganese complexes in amounts up to 0.1% by weight.

In addition to the bleach system composed of bleaches, bleach activators and if appropriate bleach catalysts described, it is also possible to use systems with enzymatic peroxide release or photoactivated bleach systems for the inventive washing and cleaning compositions.

For a series of applications, it is appropriate when the inventive washing and cleaning compositions comprise enzymes. Enzymes used with preference in washing and cleaning compositions are proteases, amylases, lipases and cellulases. Amounts of the enzymes preferably of from 0.1 to 1.5% by weight, especially preferably from 0.2 to 1.0% by weight, of the finished enzyme are added. Suitable proteases are, for example, Savinase and Esperase (manufacturer: Novo Nordisk). A suitable lipase is, for example, Lipolase (manufacturer: Novo Nordisk). A suitable cellulase is, for example, Celluzym (manufacturer: Novo Nordisk). It is also possible to use peroxidases to activate the bleach system. It is possible to use individual enzymes or a combination of different enzymes. If appropriate, the inventive washing and cleaning composition may also comprise enzyme stabilizers, for example calcium propionate, sodium formate or boric acid or salts thereof, and/or antioxidants.

The constituents of washing and cleaning compositions are known in principle to those skilled in the art. The lists of suitable constituents above and below represent merely an illustrative selection of the known suitable constituents.

The inventive washing and cleaning compositions may, as well as the main components specified so far, also comprise further customary additives in the amounts customary therefor:

Known dispersants, for example naphthalenesulfonic acid condensates or polycarboxylates, pH-regulating compounds for example alkalis or alkali donors (NaOH, KOH, pentasodium metasilicate) or acids (hydrochloric acid, phosphoric acid, amidosulfuric acid, citric acid) buffer systems, for example acetate or phosphate buffer, perfume, dyes, biocides, for example isothiazolinones or 2-bromo-2-nitro-1,3-propanediol, solubilizers/hydrotropes, for example cumenesulfonates, toluenesulfonates, short-chain fatty acids, urea, alcohols or alkyl/aryl phosphates, alkyl/aryl polyglycol phosphates, foam regulators for stabilizing or suppressing foam, skincare agents and anticorrosives, disinfectant components or systems, for example those which release chlorine or hypochlorous acid, for example dichloroisocyanurate or iodine.

The washing compositions additionally comprise, if appropriate, soil release agents, for example polyether esters, incrustation inhibitors, ion exchangers, graying inhibitors, optical (fluorescent) brighteners, dye transfer inhibitors, for example polyvinylpyrrolidone, thickeners and standardizers and formulating agents; cleaning compositions may additionally comprise solvents, for example short-chain alkyl oligoglycols such as butylglycol, butyldiglycol, propylene glycol monomethyl ether, alcohols such as ethanol, i-propanol, aromatic solvents such as toluene, xylene, N-alkylpyrrolidones or alkylene carbonates, thickeners, for example polysaccharides, and/or lightly crosslinked polycarboxylates (for example Carbopol® from Goodrich) finely divided abrasive components, for example quartz or marble flour, chalk, diatomaceous earth, pumice or else jeweler's rouge or emery.

The washing compositions are usually, but not exclusively, present in solid, pulverulent form, in which case, they generally additionally comprise customary standardizers which impart to them good free flow, dosability and solubility and prevent caking and dusting, for example, sodium sulfate or magnesium sulfate. The pulverulent washing compositions have, in the conventional form, an average bulk density of approx. 450 g/l. Compact or ultra-compact washing compositions and extrudates have a bulk density of >600 g/l. These are becoming ever more significant.

If they are to be used in liquid form, they may be present in the form of aqueous microemulsions, emulsions or solutions. In liquid washing compositions, it is additionally possible to use solvents, for example ethanol, i-propanol, 1,2-propylene glycol, or butylglycol.

In the case of inventive washing compositions in gel form, it is additionally possible to use thickeners, for example, polysaccharides and/or lightly crosslinked polycarboxylates (for example Carbopol® from Goodrich).

In the case of tableted washing compositions, tableting aids are additionally required, for example polyethylene glycols with molar masses >1000 g/mol, as are polymer dispersions, and tablet disintegrants for example cellulose derivatives, crosslinked polyvinylpyrrolidone, crosslinked polyacrylates or combinations of acids, for example citric acid+sodium bicarbonate, to name just a few.

The cleaning compositions are usually, but not exclusively, aqueous and are present in the form of microemulsions, emulsions or solutions.

If they should be present in solid, pulverulent form, customary standardizers which impart to them good free flow, dosability and solubility and/or prevent caking and dusting, for example sodium sulfate or magnesium sulfate, can additionally be used.

In the case of detergents in tablet form, tableting aids, for example polyethylene glycols with molar masses >1000 g/mol, polymer dispersions, and tablet disintegrants, for example cellulose derivatives, crosslinked polyvinylpyrrolidone, crosslinked polyacrylates or combinations of acids, for example citric acid+sodium bicarbonate, to name just a few, are additionally required.

The present invention is illustrated in detail by the examples which follow.

### EXAMPLES

### Example 1

### Mixture with the Main Component

### C₁₆-C₁₈-Fatty Alcohol−50 EO+Decanoic Acid (Degree of Esterification 95%)

The ethoxylate formed from 1 eq of C16C18−fatty alcohol and 50 eq of ethylene oxide is produced as Lutensol AT 50 by BASF by means of basic catalysis with KOH and subsequent neutralization, and sold.

Lutensol AT 50 (1693 g, 0.9 mol) is admixed with decanoic acid (154.8 g, 0.9 mol), para-toluenesulfonic acid (8.6 g, 0.045 mol) and toluene (750 ml) and heated on a water separator under reflux until no further water separates out (24 h). After the acidic catalyst has been neutralized with KOH (45% strength) and after the solvent has been removed under reduced pressure, 1780 g of solid (m.p. 49° C.) are obtained with a degree of esterification of 95% (¹H NMR & amount of water separated out).

### Comparative Example 2

### Mixture with the Main Component

C₁₆-C₁₆-fatty alcohol−50 EO+decanoic acid (degree of esterification 83%)

The ethoxylate formed from 1 eq of C16C18−fatty alcohol and 50 eq of ethylene oxide is produced as Lutensol AT 50 by BASF by means of basic catalysis with KOH and subsequent neutralization, and sold.

Lutensol AT 50 (245.8 g, 0.10 mol) is admixed with decanoic acid (17.2 g, 0.10 mol), para-toluenesulfonic acid (1.0 g, 0.005 mol) and toluene (100 g) and heated on a water separator at 140° C. for 6 h. After the solvent has been removed under reduced pressure, 258 g of solid (m.p. 46° C.) are obtained with a degree of esterification of 83% (¹H NMR & amount of water separated out).

### Comparative Example 3

### Mixture with the Main Component

Octanol−4.5 EO+octanoic acid

### a) Preparation of the Alkyl Alkoxylate:

Octanol (263 g, 2 mol) is admixed with powdered KOH (1.7 g, 0.030 mol) in a 21 pressure autoclave from Mettler and dewatered at 95° C. and 20 mbar for 1 h. The autoclave is then inertized twice with nitrogen and heated to 120° C. Within 5 h, ethylene oxide (397 g, 9 mol) is metered in at 120° C. up to a maximum pressure of 6 bar and, after the addition has ended, stirred for another 5 h. This affords octanol -4.5 EO (660 g; OH number 178 mg KOH/g, theory 171 mg KOH/g).

### b) Esterification:

Octanol−4.5 EO (150 g, 0.46 mol) is admixed with octanoic acid (67 g, 0.46 mol), para-toluenesulfonic acid (5.8 g, 0.034 mol) and toluene (200 ml) and boiled at 130° C. on a water separator for 9 h. After neutralization with NaOH and removal of the solvent, 210 g of the desired liquid compound are obtained with a degree of esterification of approx. 90% (¹H NMR).

### Comparative Example 4

### Mixture with the Main Component

Octanol−20 EO−1 PO+octanoic acid

### a) Preparation of the Alkyl Alkoxylate

Octanol (132 g, 1 mol) is admixed with powdered KOH (2.7 g, 0.048 mol) in a 21 pressure autoclave from Mettler and dewatered at 95° C. and 20 mbar for 1 h. The autoclave is then inertized twice with nitrogen and heated to 120° C. Within 8 h, ethylene oxide (881 g, 20 mol) is metered in at 120° C. up to a maximum pressure of 6 bar and stirred for a further 10 h. Propylene oxide (58 g, 1 mol) is then metered in at 130° C. within 1.5 h and, after the addition has ended, the mixture is stirred for another 3 h. Octanol−20 EO−1 PO is obtained (1060 g; OH number 52 mg KOH/g, theory 53 mg KOH/g) as a white solid.

### b) Esterification:

Octanol−20 EO−1 PO (150 g, 0.14 mol) is admixed with octanoic acid (20 g, 0.14 mol), para-toluenesulfonic acid (2.5 g, 0.014 mol) and toluene (200 ml) and boiled at 130° C. on a water separator for 20 h. After neutralization with NaOH and removal of the solvent, 160 g of the desired wax-like compound are obtained with a degree of esterification of >80% (¹H NMR).

### Comparative Example 5

### Mixture with the main component

### 2-propylheptyloxypropylenecosaoxyethylene glycol decanoic ester

### a) Preparation of the Alkyl Alkoxylate:

2-Propylheptanol (395.8 g, 2.5 mol; manufacturer: BASF) is admixed with powdered KOH (11 g, 0.20 mol) in a 3.5 l pressure autoclave from Mettler and dewatered at 95° C. and 20 mbar for 1 h. The autoclave is then inertized twice with nitrogen and heated to 120° C. Propylene oxide (145 g, 2 mol) is metered in up to a maximum pressure of 2 bar within 1 h and the mixture is left to stir at constant pressure for 2 h. Subsequently, ethylene oxide (880 g, 50 mol) is metered in up to a maximum pressure of 6 bar at 120° C. within 8 h and, after the addition has ended, the mixture is stirred for a further 3 h.

Subsequently, the compound is admixed with Ambosol (3 percent by weight) and filtered. 2-Propylheptyloxypropylenecosaoxyethylene glycol is obtained (2744 g; OH number 52 mg KOH/g, theory 51 mg KOH/g) as a white solid.

### b) Esterification:

2-Propylheptyloxypropylenecosaoxyethylene glycol (165 g, 0.15 mol) is admixed with decanoic acid (25.8 g, 0.15 mol), para-toluenesulfonic acid (1.4 g, 0.075 mol) and toluene (50 ml) and boiled at 140° C. on a water separator for 10 h. 189 g of wax-like solid is obtained with a degree of esterification of 82% (¹H NMR).

### Comparative Example 6

### Mixture with the Main Component

### 2-propylheptylcosaoxyethyleneoxypropylene glycol decanoic ester

### a) Preparation of the Alkyl Alkoxylate:

2-Propylheptanol (158.3 g, 1.0 mol; manufacturer: BASF) is admixed with powdered KOH (4.4 g, 0.078 mol) in a 21 pressure autoclave from Mettler and dewatered at 95° C. and 20 mbar for 1 h. The autoclave is then inertized twice with nitrogen and heated to 120° C. Within 8 h, ethylene oxide (880 g, 20 mol) is metered in up to a maximum pressure of 8 bar and, after the addition has ended, the mixture is stirred for another 6 h. The reactor is then decompressed to standard pressure and propylene oxide (58 g, 1 mol) is metered in at 120° C. up to a pressure of 7 bar within 2 h. Finally, the compound is admixed with Ambosol (3 percent by weight) and filtered. 2-Propylheptylcosaoxyethylene glycol is obtained (1030 g; OH number 54 mg KOH/g, theory 51 mg KOH/g) as a white solid.

### b) Esterification:

2-Propylheptylcosaoxyethyleneoxypropylene glycol (124.7 g, 0.12 mol) is admixed with decanoic acid (20.6 g, 0.12 mol), para-toluenesulfonic acid (1.1 g, 0.06 mol) and toluene (50 ml) and boiled at 140° C. on a water separator for 10 h. 142 g of wax-like solid with a degree of esterification of 90% (¹H NMR) are obtained.

### Use Example 7

### Foam Volume in a Machine Dishwasher

The foam volume in a machine dishwasher is tested. In this test, 10 ml of chicken egg, 19 g of a base dishwasher detergent (48% sodium metasilicate×5H₂O, 45% sodium triphosphate, 5% sodium carbonate) and 1 g of the surfactant are introduced into the machine dishwasher. The number of rotations of the spray arm is then measured at different temperatures. At a high foam level, the spray arm is slowed down; at a low foam level, it can work at maximum possible speed (approx. 150 rpm).

Various surfactants have been tested in this application.

| Name | Surfactant |
|---|---|
| A | C16C18-fatty alcohol - 50 EO + |
| | decanoic acid (degree of esterification 95%) |
| B | C16C18-fatty alcohol - 50 EO + |
| | decanoic acid (degree of esterification 83%) |
| C | Octanol - 4.5 EO + octanoic acid |
| D | Octanol - 20 EO-1 PO + octanoic acid |
| E | 2-PH-1PO-20EO + decanoic acid |
| F | 2-PH-20EO-1PO + decanoic acid |

The rotation speed was measured at 30, 40, 50, 60° C. The table which follows lists the rotor speeds in rpm at different temperatures.

| Temperature | A | B | C | D | E | F |
|---|---|---|---|---|---|---|
| 30° C. | 121 | 51 | 85 | 72 | 113 | 123 |
| 40° C. | 120 | 46 | 91 | 89 | 120 | 127 |
| 50° C. | 122 | 42 | 93 | 120 | 128 | 129 |
| 60° C. | 121 | 44 | 95 | 124 | 128 | 129 |

1-6. (canceled)

7. A composition formulation comprising a low-foam surfactant mixture comprising at least one ester represented by formula (I) 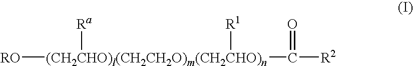
and at least one alcohol thereof represented by formula (Ia) 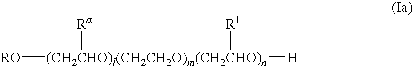
wherein
R is a branched or unbranched alkyl radical having from 8 to 22 carbon atoms;
R^{a}, R¹ are each independently hydrogen or a branched or unbranched alkyl radical having from 1 to 5 carbon atoms;
R² is a branched or unbranched alkyl radical having from 5 to 17 carbon atoms;
l, n are each independently from 1 to 5 and
m is from 38 to 70, and
wherein the ratio of the molar amounts of the at least one ester (I) to the at least one alcohol (Ia) is at least 17:3 and l+n+m is from 46 to 75, wherein said formulation exists in solid form at room temperature and further comprises a builder.

8. The formulation according to claim 7, wherein the low-foam surfactant mixture comprises at least one ester represented by formula (II) 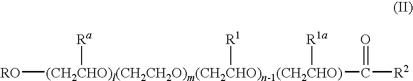
and at least one alcohol thereof represented by formula (IIa) 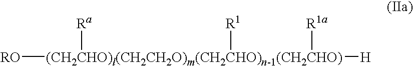
wherein R^{1a} is a branched or unbranched alkyl radical having from 1 to 5 carbon atoms and R, R^{a}, R¹, R², l, m and n are each as defined in claim 1.

9. The formulation according to claim 7, wherein at least one of the following statements is satisfied:
a) R is a branched or unbranched alkyl radical having from 12 to 22 carbon atoms;
b) R^{a}, R¹ are each independently hydrogen, methyl or ethyl;
c) R^{1a} is methyl or ethyl;
d) R² is a branched or unbranched alkyl radical having from 5 to 13 carbon atoms;
e) n=1 and l=5;
f) m is from 39 to 54.

10. The formulation according to claim 7, wherein the mean molecular weight is from 1800 g/mol to 4000 g/mol.

11. The formulation according to claim 7, wherein the beginning of the melting range of the mixture is above 35° C.

12. A method of cleaning and washing comprising adding a solid composition formulation comprising a low-foam surfactant mixture as specified in claim 7, at room temperature.

13. The formulation according to claim 7, wherein said formulation has an HLB value of from 17.7 to 20.

14. The formulation according to claim 7, wherein said formulation has an HLB value of from 17.7 to 18.5.

15. The formulation according to claim 7, wherein the ratio of the molar amounts of the at least one ester (I) to the at least one alcohol (Ia) is at least 17:3.

16. The formulation according to claim 8, wherein the ratio of the molar amounts of the at least one ester (II) to the at least one alcohol (IIa) is at least 17:3.

17. The formulation according to claim 7, wherein the degree of esterification is at least 85%.

18. The formulation according to claim 7, wherein the sum of l+n+m is from 40 to 80.

19. The formulation according to claim 7, wherein the mean molecular weight is within a range from 1800 g/mol to 4000 g/mol.

20. The formulation according to claim 7, wherein R² is a branched or unbranched alkyl radical having from 5 to 13 carbon atoms.
